(19) United States
(12) Patent Application Publication
(10) Pub. No.: US 2025/0333012 A1
(43) Pub. Date: Oct. 30, 2025

(54) POWER SUPPLY RAIL AND VEHICLE SEAT

(71) Applicant: TS TECH CO., LTD., Asaka-shi, Saitama (JP)

(72) Inventor: Tatsuya SUGITA, Tochigi (JP)

(21) Appl. No.: 18/868,400

(22) PCT Filed: May 24, 2023
(86) PCT No.: PCT/JP2023/019333

§ 371 Date: Nov. 22, 2024

Related U.S. Application Data
(60) Provisional application No. 63/365,303, filed on May 25, 2022.

(30) Foreign Application Priority Data
Mar. 29, 2023 (JP) 2023-053980

(51) Int. Cl. B60R 16/037; B60N 2/07; B60R 16/02

(52) U.S. Cl. CPC B60R 16/037; B60R 16/0215; B60N 2/07

(57) ABSTRACT

A power supply rail capable of suppressing abnormal noise caused by contact between a guide belt and a casing is provided. A power supply rail includes a cylindrical casing, a sliding portion which is attached to the casing to be movable along a predetermined direction, a flexible flat cable which is accommodated in the casing and extends in the predetermined direction, a movable terminal portion which is attached to the sliding portion, a fixed terminal portion which is attached to the casing, a guide belt which guides the flexible flat cable, and a holding member that holds the guide belt. The holding member includes a locking portion which locks at least one end of the guide belt in the width direction and holds the guide belt by the locking portion.

### TECHNICAL FIELD

The present invention relates to a power supply rail and a vehicle seat and particularly to a power supply rail for supplying power to a vehicle seat provided in a vehicle such as an automobile and a vehicle seat including the power supply rail.

### BACKGROUND ART

Conventionally, a power supply rail for supplying power to a sliding seat from a power source on a vehicle body side of an automobile or the like has been known. For example, a power supply rail described in PATENT LITERATURE 1 includes a flexible flat cable which is accommodated in a long cylindrical casing, a fixed terminal which is connected to wiring of a power source circuit of a vehicle, and a movable terminal which is connected to wiring of a sliding seat, and supplies power from the power source circuit of the vehicle to the sliding seat through the flexible flat cable.

The power supply rail described in PATENT LITERATURE 1 includes a guide plate (guide belt) which holds down and guides the flexible flat cable in response to the expansion and contraction movement of the flexible flat cable. Then, in order to prevent the flexible flat cable accommodated in the casing from generating abnormal noise caused by rattling, the inner surface of the casing is provided with a protrusion having a triangular cross section that comes into contact with the flexible flat cable.

### CITATION LIST

### Patent Literature

PATENT LITERATURE 1: JP 2020-032862 A

### SUMMARY OF INVENTION

### Technical Problem

However, in the power supply rail described in PATENT LITERATURE 1, there is a risk that abnormal noise may be generated, particularly, in a portion in which the guide plate is curved in that the guide plate contacts the inner surface of the casing when the guide plate is deformed due to gravity or the like and the vehicle body is vibrated in a vehicle traveling state.

The present invention has been made in view of the above-described problems and an object of the present invention is to provide a power supply rail and a vehicle seat capable of suppressing abnormal noise caused by contact between a guide belt and a casing.

### Solution to Problem

According to a power supply rail of the present invention, the above-described problems are solved by a power supply rail including: a casing which extends in a predetermined direction and has a cylindrical shape; a sliding portion which is attached to the casing to be movable along the predetermined direction; a flexible flat cable which is accommodated in the casing and extends along the predetermined direction; a movable terminal portion which is provided at one end of the flexible flat cable and is attached to the sliding portion; a fixed terminal portion which is provided at the other end of the flexible flat cable and is attached to the casing; a guide belt which is accommodated in the casing, extends in the predetermined direction along the flexible flat cable, and guides the flexible flat cable; and a holding member that holds the guide belt, wherein the flexible flat cable includes a tip portion which is connected to the movable terminal portion and a base end which is connected to the fixed terminal portion, wherein the guide belt includes a moving end which is attached to the sliding portion together with the tip portion, a fixed end which is fixed to the casing together with the base end, and a curved portion which is provided between the moving end and the fixed end in a curved state, and wherein the holding member is provided between the fixed end and the curved portion, includes a locking portion which locks at least one end of the guide belt in a width direction, and holds the guide belt by the locking portion.

With the above-described configuration, since the guide belt is held by the holding member provided between the fixed end and the curved portion, deformation of the guide belt due to gravity or the like is less likely to occur, and the contact between the guide belt and the casing can be suppressed.

Specifically, since the guide belt is held by the locking portion locking the upper end or the lower end of the guide belt, it is possible to suppress the guide belt from contacting the casing inner surface by stabilizing the posture of the guide belt.

Thus, it is possible to suppress abnormal noise caused by contact between the guide belt and the casing.

At this time, a base portion may extend in the predetermined direction along the guide belt, and the locking portion may extend in the thickness direction from at least one end of the base portion in the width direction at a central part of the base portion in an extension direction and overlap the guide belt in the width direction.

With the above-described configuration, since the guide belt is held by the locking portion overlapping in the width direction of the guide belt, it is possible to suppress the guide belt from contacting the casing inner surface.

At this time, the base portion may extend in the predetermined direction along the guide belt, and the locking portion may extend in the thickness direction from at least one end of the base portion in the width direction at a central part of the base portion in an extension direction and overlap the guide belt in the width direction.

With the above-described configuration, since the locking portion is provided at the central part in the longitudinal direction of the holding member and holds the upper end of the guide belt, it is possible to further suppress the guide belt from contacting the casing inner surface by further stabilizing the posture of the guide belt.

At this time, the base portion may extend in the predetermined direction along the guide belt, and the locking portion may extend in the thickness direction from at least one end of the base portion in the width direction in at least one side end part of the base portion in an extension direction and overlap the guide belt in the width direction. With the above-described configuration, since the locking portion is provided at the side end part in the extension direction of the holding member and holds the upper end or the lower end of the guide belt, it is possible to further suppress the guide belt from contacting the casing inner surface by further stabilizing the posture of the guide belt.

At this time, the base portion may extend in the predetermined direction along the guide belt, and the locking portion may extend in the thickness direction from at least one end of the base portion in the width direction at both end parts of the base portion in an extension direction and overlap the guide belt in the width direction.

With the above-described configuration, since the locking portion is provided at both end parts in the extension direction in the longitudinal direction of the holding member and holds the upper end or the lower end of the guide belt, it is possible to further suppress the guide belt from contacting the casing inner surface by further stabilizing the posture of the guide belt.

At this time, the base portion may extend in the predetermined direction along the guide belt and be provided at a position facing a surface opposite to a surface near the flexible flat cable in the guide belt, and the locking portion may extend in the thickness direction from both ends of the base portion in the width direction and overlap the guide belt in the width direction.

With the above-described configuration, since the guide belt is provided between the holding member and the flexible flat cable and the holding member is attached to cover the guide belt, it is possible to further suppress the guide belt from contacting the casing inner surface by further stabilizing the posture of the guide belt.

At this time, the base portion may extend in the predetermined direction along the guide belt and be provided at a position facing a surface opposite to a surface near the flexible flat cable in the guide belt, the locking portion may include a bulging portion which extends in the thickness direction from at least one end of the base portion in the width direction at a central part of the base portion in an extension direction and overlaps the guide belt in the width direction and a claw portion which extends in the thickness direction from at least one end of the base portion in the width direction at both end parts of the base portion in an extension direction and overlaps the guide belt in the width direction, and the length of the bulging portion may be longer than the length of the claw portion in the thickness direction.

With the above-described configuration, it is possible to suppress the flexible flat cable from contacting the guide belt by the bulging portion while locking the guide belt by the claw portion.

Further, according to a vehicle seat including the power supply rail of the present invention, the above-described problems are solved by a vehicle seat including: a seat body which includes a seat cushion and a seat back; a slide rail which extends in the predetermined direction and supports the seat body to be movable in the predetermined direction; and a power supply rail, wherein the power supply rail is disposed on the side of the slide rail along a direction in which the slide rail extends.

With the above-described configuration, it is possible to suppress abnormal noise caused by contact between the guide belt and the casing.

### ADVANTAGEOUS EFFECTS OF INVENTION

According to the present invention, it is possible to suppress abnormal noise caused by contact between the guide belt and the casing.

Further, it is possible to further suppress the guide belt from contacting the casing inner surface by further stabilizing the posture of the guide belt.

Further, it is possible to suppress the flexible flat cable from contacting the guide belt by the bulging portion while locking the guide belt by the claw portion.

### BRIEF DESCRIPTION OF DRAWINGS

FIG. 1 is a side view of a vehicle seat of this embodiment.

FIG. 2 is a perspective view of a slide rail, which shows a part of an upper rail.

FIG. 3 is a perspective view of the slide rail, which shows a part of a lower rail and the upper rail.

FIG. 4 is a perspective view of a power supply rail.

FIG. 5 is a side view of the power supply rail.

FIG. 6A is a top view of the inside of a casing of the power supply rail, which shows a state in which a sliding portion is located at a forward position.

FIG. 6B is a top view of the inside of the casing of the power supply rail, which shows a state in which the sliding portion is located at an intermediate position.

FIG. 6C is a top view of the inside of the casing of the power supply rail, which shows a state in which the sliding portion is located at a backward position.

FIG. 7 is a cross-sectional view taken along a line VII-VII of FIG. 6B.

FIG. 8 is a perspective view of a holding member, which shows a state in which the holding member is attached to a guide belt.

FIG. 9 is a cross-sectional view taken along a line IX-IX of FIG. 8.

FIG. 10A is a cross-sectional view taken along a line X-X of FIG. 8.

FIG. 10B is a diagram showing a modified example of the holding member.

FIG. 11A is a diagram of a power supply rail of a first modified example, which shows a guide rail and a flexible flat cable.

FIG. 11B is a diagram of a power supply rail of a second modified example, which shows a guide rail and a flexible flat cable.

FIG. 11C is a diagram of a power supply rail of a third modified example, which shows a guide rail and a flexible flat cable.

FIG. 12 is a side view of a vehicle seat of a fourth modified example.

FIG. 13 is a side view of a vehicle seat of a fifth modified example.

FIG. 14 is a top view of the inside of a casing of a power supply rail of the fifth modified example.

### DESCRIPTION OF EMBODIMENTS

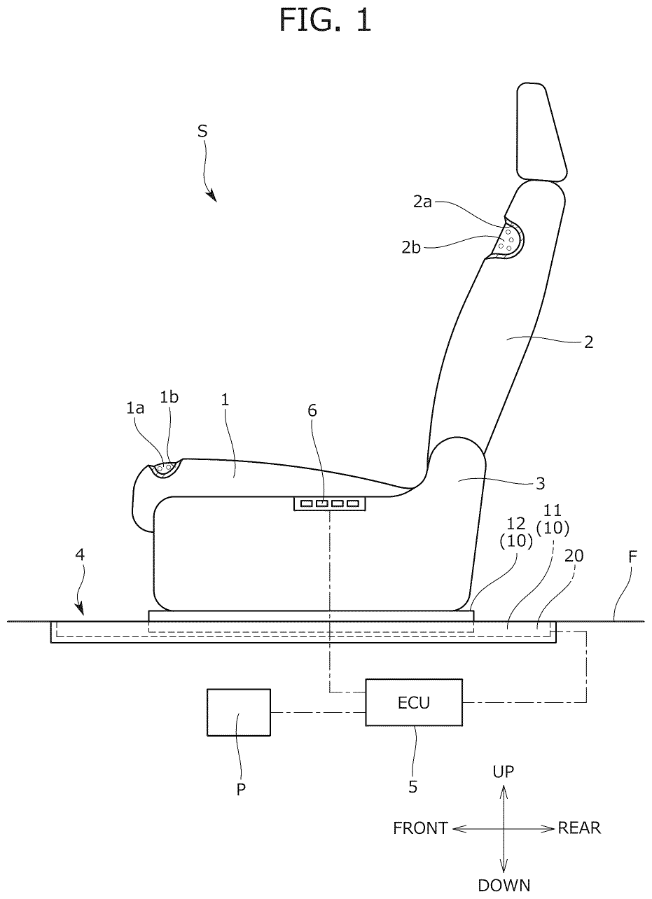

Hereinafter, embodiments of the present invention will be described with reference to FIGS. 1 to 10B.

In the following description, the “front to rear direction” refers to the front to rear direction of the vehicle seat, which coincides with the traveling direction when the vehicle is traveling. Further, the “seat width direction” refers to the width direction of the vehicle seat, which coincides with the right to left direction when viewed from an occupant sitting on the vehicle seat. Further, the “up to down direction” refers to the up to down direction of the vehicle seat, which coincides with the vertical direction when the vehicle is traveling on the horizontal plane.

### Entire Configuration of Seat

As shown in FIG. 1, a vehicle seat S mainly includes a seat body which is equipped with a seat cushion 1, a seat back 2, and a seat support member 3, a rail device 4 which is attached to a floor F of a vehicle body and is supported to be movable in a predetermined direction, specifically, the front to rear direction, a control device 5 (ECU) which controls the rail device 4, and a switch 6 which is operated to move the rail device 4.

As shown in FIG. 1, the seat cushion 1 is a seating portion that supports the occupant from below, and is configured by placing a pad material la on a cushion frame that serves as a skeleton and covering the pad material with a skin material 1b.

The seat back 2 is a backrest portion that supports the back of the occupant from behind, and is configured by placing a pad material 2a on a back frame that serves as a skeleton and covering the pad material with a skin material 2b.

The seat support member 3 is a member that supports the seat cushion 1 and the seat back 2 and is attached to the rail device 4. The control device 5 is an electronic control device and is connected to a power source P mounted on the vehicle body, the rail device 4, and the switch 6. The switch 6 is provided on the side of the seat support member 3 and has a button corresponding to forward movement and a button corresponding to reverse movement.

The occupant can sit on the seat cushion 1 and operate the switch 6 to activate the rail device 4 so that the vehicle seat S moves forward and backward relative to the floor F.

As shown in FIG. 1, the rail device 4 includes a slide rail 10 which extends in the front to rear direction as a predetermined direction and a power supply rail 20 which is provided on the side of the slide rail 10 and extends in the front to rear direction. Furthermore, although not shown in FIG. 1, a pair of slide rails 10 are provided on the right and left sides.

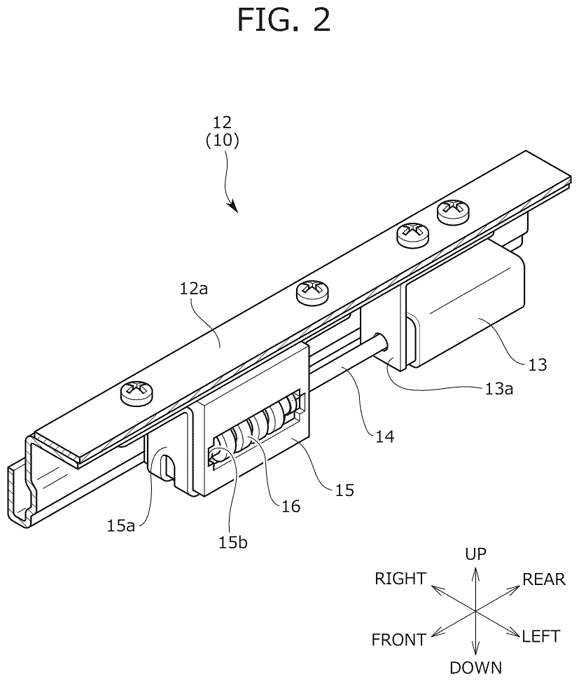

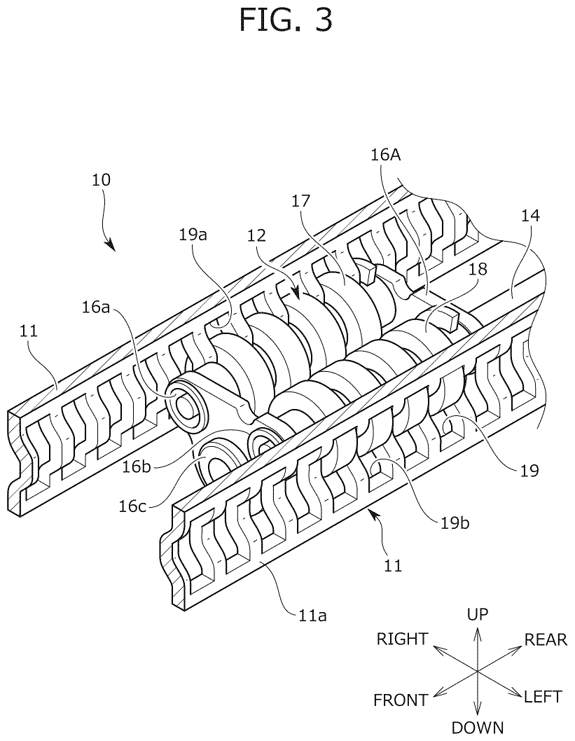

As shown in FIGS. 2 and 3, the slide rail 10 is a rail member that supports the seat body to be movable forward and backward relative to the floor F, and includes a lower rail 11 fixed to the floor F and an upper rail 12 fixed to the seat support member 3.

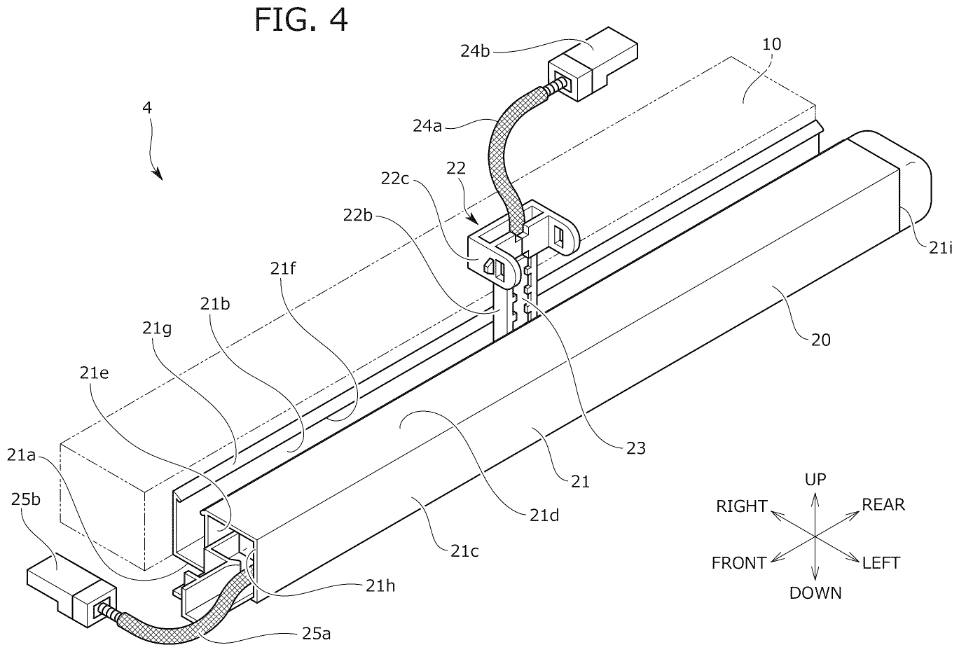

As shown in FIG. 4, the power supply rail 20 is a power supply device that electrically connects the power source P provided in the vehicle body to the vehicle seat S and supplies power from the power source P to the slide rail 10.

As shown in FIG. 1, the rail device 4 is disposed in a rail groove formed in the floor F. The upper surface of the rail device 4 is disposed on the same plane as the upper surface of the floor F. By disposing the rail device 4 in the rail groove, it is possible to prevent the rail device 4 from protruding from the floor F.

In this embodiment, as shown in FIG. 4, the power supply rail 20 is disposed on the left side of the left slide rail 10 in the seat width direction. However, the present invention is not limited thereto, and the power supply rail 20 may be disposed on the right side of the left slide rail 10 or disposed on the side of the right slide rail 10.

### Slide Rail

The slide rail 10 is a rail member that supports the seat body to be movable in a predetermined direction, specifically, the front to rear direction. As shown in FIGS. 2 and 3, the slide rail 10 includes a lower rail 11 which extends in the front to rear direction and an upper rail 12 which is attached to the lower rail 11 to be movable forward and backward and extends in the front to rear direction.

The lower rail 11 includes a rail bottom wall which is fixed to the floor F, right and left rail outer walls which extend upward from the right and left edges of the rail bottom wall, rail upper walls which extend from the upper ends of the right and left rail outer walls in mutually approaching directions, and right and left rail inner walls 11a which extend downward from the ends of the rail upper walls. Furthermore, FIG. 3 only shows the rail inner wall 11a in the lower rail 11.

The upper rail 12 is fixed to the lower portion of the seat support member 3 and is provided to be movable forward and backward relative to the lower rail 11. Both side walls of the upper rail 12 are respectively provided at the positions facing the rail inner walls 11a. Furthermore, the upper rail 12 is formed to be shorter than the lower rail 11 in the front to rear direction.

As shown in FIG. 2, the upper rail 12 includes an electric motor 13, a drive shaft 14 which is connected to the output shaft of the electric motor 13, a gear casing 15 which is connected to the drive shaft 14, and a screw member 16 that is accommodated in the gear casing 15. The upper rail 12 slides in the front to rear direction relative to the lower rail 11 as the screw member 16 is driven by the electric motor 13.

Furthermore, the upper rail 12 is attached to the lower rail 11 through, for example, wheels, ball bearings, roller bearings, and the like so that the upper rail 12 is slidable smoothly relative to the lower rail 11.

The electric motor 13 is a drive unit that slides the upper rail 12, and is supplied with power from the power supply rail 20 through a connector (not shown). The electric motor 13 is formed in a cylindrical shape extending in the front to rear direction and is attached to an upper surface 12a of the upper rail 12 through a motor bracket 13a.

The drive shaft 14 is a rotation shaft which drives the screw member 16 and is connected to the output shaft of the electric motor 13. The drive shaft 14 extends in the front to rear direction and is rotatably supported by the gear casing 15. The output shaft of the electric motor 13 and the drive shaft 14 are arranged on the same straight line.

The gear casing 15 is formed in a rectangular parallelepiped box shape that is long in the front to rear direction and accommodates the screw member 16. The gear casing 15 is attached to the upper surface 12a of the upper rail 12 through the gear bracket 15a in front of the electric motor 13. The gear casing 15 is provided with a casing opening 15b which is an opening portion for exposing the screw member 16 to the side.

As shown in FIG. 3, the screw member 16 includes a first screw member 17 and a second screw member 18 that are provided to be movable in the front to rear direction relative to the lower rail 11. The first screw member 17 and the second screw member 18 each extend in the front to rear direction and are arranged in parallel to each other in the gear casing 15.

The first screw member 17 is disposed along the right side surface of the gear casing 15, and the second screw member 18 is disposed on the left side surface of the gear casing 15. The drive shaft 14 is disposed below the intermediate portion between the first screw member 17 and the second screw member 18.

The screw member 16 is provided in pair at both ends of the first screw member 17 and the second screw member 18 in the front to rear direction and includes a bearing portion 16A that axially supports the drive shaft 14, the first screw member 17, and the second screw member 18. Specifically, the bearing portion 16A includes a first bearing portion 16a which rotatably supports the front and rear ends of the first screw member 17, a second bearing portion 16b which rotatably supports the front and rear ends of the second screw member 18, and a third bearing portion 16c which rotatably supports the drive shaft 14.

When the drive shaft 14 rotates, the first screw member 17 and the second screw member 18 rotate in the same direction by a drive gear (not shown) meshing with the drive shaft 14.

As shown in FIG. 3, the lower rail 11 is provided with a screw engagement portion 19 which engages with the screw member 16. Specifically, a first engagement portion 19a is formed on the right rail inner wall 11a adjacent to the first screw member 17 of the upper rail 12. Further, a second engagement portion 19b is formed on the left rail inner wall 11a adjacent to the second screw member 18 of the upper rail 12.

The first engagement portion 19a and the second engagement portion 19b are a plurality of hole portions formed in the rail inner wall 11a to be arranged side by side in the front to rear direction. Thus, when the screw member 16 rotates by the rotation of the drive shaft 14, the first screw member 17 meshes with the hole portion of the first engagement portion 19a and the second screw member 18 meshes with the hole portion of the second engagement portion 19b so that the upper rail 12 moves in the front to rear direction relative to the lower rail 11.

### Power Supply Rail

The power supply rail 20 is a power supply device which supplies power from the power source P to the slide rail 10. As shown in FIGS. 1 and 4, the power supply rail 20 is disposed on the side of the slide rail 10 along the direction in which the slide rail 10 extends.

The power supply rail 20 includes a casing 21 which extends in a predetermined direction, that is, the front to rear direction, a sliding portion 22 which slides in accordance with the movement of the upper rail 12, a flexible flat cable 23 which supplies power from the power source P to the slide rail 10, a movable terminal portion 24 which supplies power from the flexible flat cable 23 to the slide rail 10, a fixed terminal portion 25 which supplies power from the power source P to the flexible flat cable 23, a guide belt 26 which guides the flexible flat cable 23, and a holding member 27 that holds the guide belt 26.

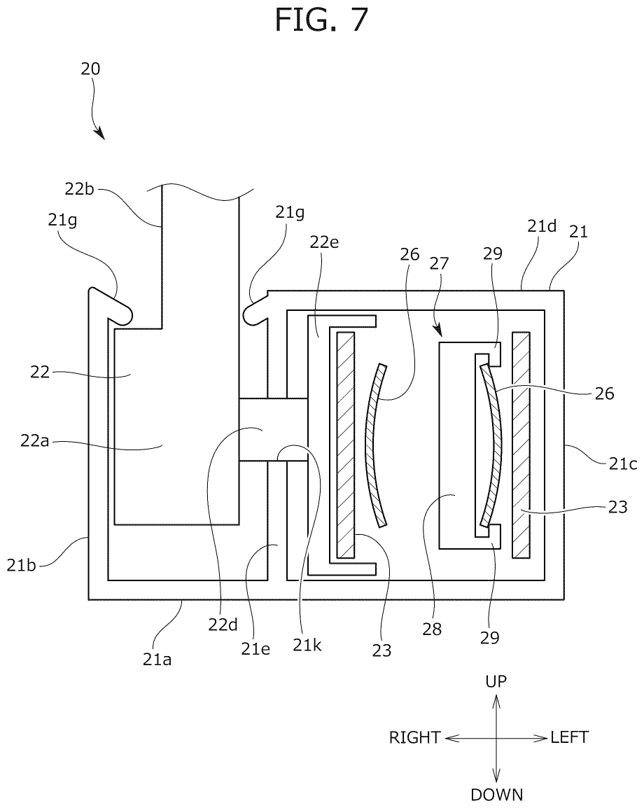

As shown in FIGS. 4 and 7, the casing 21 is a cylindrical member that is made of, for example, metal such as aluminum and extends in the front to rear direction as a predetermined direction. The casing 21 is disposed adjacent to the slide rail 10 in the rail groove formed on the floor F.

The casing 21 includes a casing bottom wall 21a which is fixed to the rail groove of the floor F, a right wall portion 21b and a left wall portion 21c which extend upward substantially perpendicularly to the casing bottom wall 21a from both right and left ends of the casing bottom wall 21a, an upper wall portion 21d which extends from the upper end of the left wall portion 21c to the right substantially in parallel to the casing bottom wall 21a, and an intermediate wall portion 21e which extends downward substantially in parallel to the left wall portion 21c from the tip of the upper wall portion 21d and is connected to the casing bottom wall 21a.

As shown in FIGS. 4 and 7, a slit 21f which extends in the front to rear direction is formed between the left wall portion 21c and the intermediate wall portion 21e in the casing 21. The sliding portion 22 is slidable relative to the casing 21 through the slit 21f.

A canopy portion 21g is formed in the opening portion of the slit 21f. Specifically, the canopy portion 21g extends obliquely downward from the right wall portion 21b and the intermediate wall portion 21e toward the inside of the slit 21f. Since foreign matter is difficult to enter the casing 21 from the slit 21f by the canopy portion 21g, breakage of the flexible flat cable 23 can be suppressed.

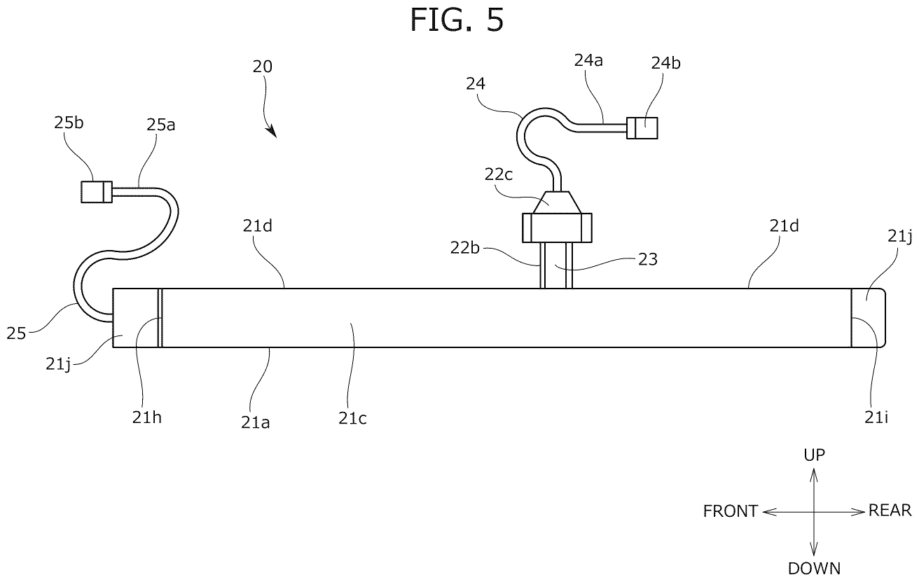

As shown in FIG. 5, the fixed terminal portion 25 is connected to a front end 21h of the casing 21. A cover 21j is attached to the front end 21h and a rear end 211 of the casing 21. That is, a space surrounded by the casing bottom wall 21a, the left wall portion 21c, the upper wall portion 21d, and the intermediate wall portion 21e of the casing 21 is closed by the cover 21j.

Further, an opening 21k that penetrates the sliding portion 22 in the right to left direction is formed at the intermediate portion of the intermediate wall portion 21e in the up to down direction. The opening 21k is formed in the intermediate wall portion 21e to extend in the front to rear direction.

As shown in FIGS. 4 and 7, the sliding portion 22 is attached to the casing 21 to be slidable along the front to rear direction. The sliding portion 22 includes a main body portion 22a which is disposed in the slit 21f, a protrusion portion 22b which extends upward from the main body portion 22a and protrudes above the upper wall portion 21d, a connector attachment portion 22c which is provided at the upper end of the protrusion portion 22b, a connection portion 22d which extends from the main body portion 22a to the left through the opening 21k, and a flat cable attachment portion 22e to which the flexible flat cable 23 is attached.

As shown in FIG. 4, the connector attachment portion 22c is disposed above the slide rail 10 (specifically, the upper surface of the lower rail 11) and the upper wall portion 21d of the casing 21. When the seat support member 3 moves in the front to rear direction by the slide rail 10, a part of the seat support member 3 comes into contact with the connector attachment portion 22c, so that the sliding portion 22 moves in the front to rear direction together with the seat support member 3.

Thus, when the seat support member 3 moves in the front to rear direction by the slide rail 10, the movable terminal portion 24 provided in the connector attachment portion 22c also moves in the front to rear direction, so that power can be always supplied to the upper rail 12 in the vicinity of the upper rail 12 of the slide rail 10.

The flexible flat cable 23 is a group of flexible transmission lines in which a plurality of metal plates (for example, copper plates) made of a conductor are arranged in the width direction and the outer surfaces of the plates are covered with heat-resistant insulating tape.

As shown in FIGS. 4 to 6A, the flexible flat cable 23 is accommodated in the casing 21 and extends in the front to rear direction. Specifically, the flexible flat cable 23 extends in the up to down direction along the protrusion portion 22b, is attached to the flat cable attachment portion 22e in a bent state, and extends backward inside the casing 21. Then, the flexible flat cable 23 is curved and folded back inside the casing 21 and extends forward to be connected to the fixed terminal portion 25 at the front end 21h of the casing 21.

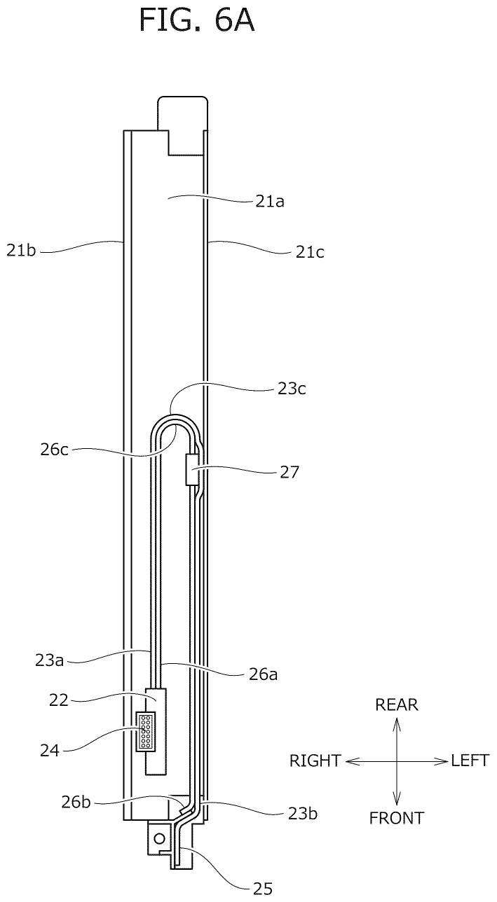

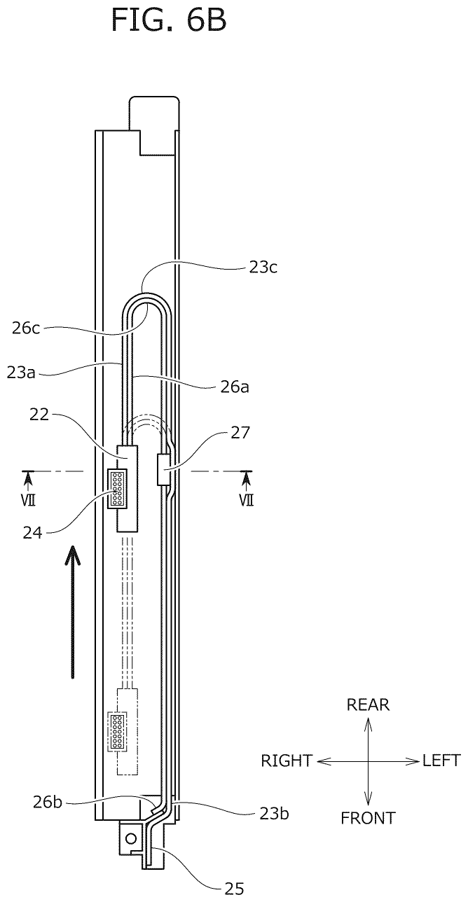

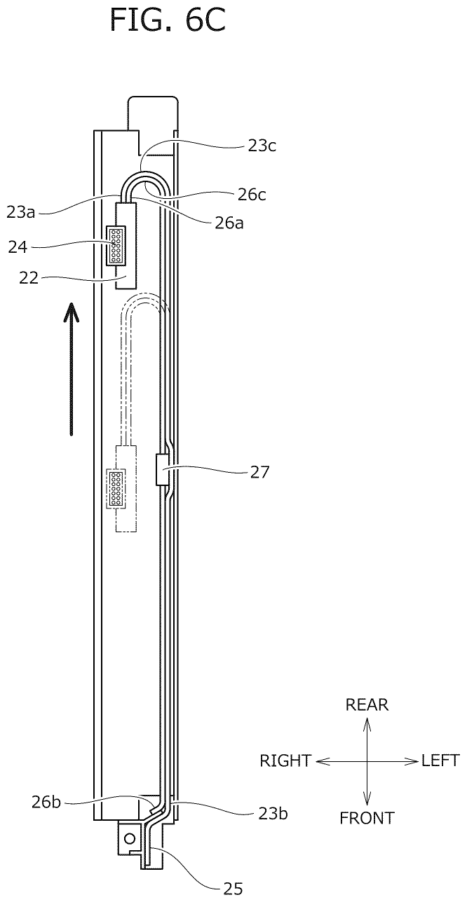

As shown in FIG. 6A, the flexible flat cable 23 is a long band-shaped cable that extends substantially in the front to rear direction. The flexible flat cable 23 is disposed inside the casing 21 so that the thickness direction of the flexible flat cable 23 coincides with the right to left direction of the casing 21, the width direction coincides with the up to down direction of the casing 21, and the longitudinal direction coincides with the front to rear direction of the casing 21.

The flexible flat cable 23 includes a tip portion 23a which is connected to the movable terminal portion 24, a base end 23b which is connected to the fixed terminal portion 25, and an intermediate portion 23c which is provided between the tip portion 23a and the base end 23b in a curved state. The intermediate portion 23c is a part of the cable intermediate portion between the tip portion 23a and the base end 23b of the flexible flat cable 23, and is a portion that is curved into a substantially U-shape in top view as the sliding portion 22 moves.

As shown in FIGS. 4 to 6A, the movable terminal portion 24 is provided at the tip portion 23a of the flexible flat cable 23 and is attached to the connector attachment portion 22c of the sliding portion 22. The movable terminal portion 24 includes a movable cable 24a which is connected to the tip portion 23a of the flexible flat cable 23 and a movable connector 24b which is connected to a connector (not shown) of the upper rail 12.

As described above, when the seat support member 3 moves in the front to rear direction by the slide rail 10, the movable terminal portion 24 provided in the connector attachment portion 22c also moves in the front to rear direction. Therefore, since the movable connector 24b moves in accordance with the movement of the upper rail 12 in the front to rear direction, power can be supplied to the upper rail 12.

As shown in FIGS. 4 to 6A, the fixed terminal portion 25 is provided at the base end 23b of the flexible flat cable 23 and is attached to the front end 21h of the casing 21. The fixed terminal portion 25 includes a fixed cable 25a which is connected to the base end 23b of the flexible flat cable 23 and a fixed connector 25b which is connected to the power source P provided in the vehicle body.

The fixed connector 25b is connected to the power source P through the control device 5. Since the fixed terminal portion 25 and the movable terminal portion 24 are electrically connected to each other through the flexible flat cable 23, power from the power source P can be supplied to the slide rail 10.

As shown in FIGS. 4 and 6A, the guide belt 26 is accommodated in the casing 21, extends along the front to rear direction, and guides the flexible flat cable 23. Specifically, the guide belt 26 is attached to the sliding portion 22 together with the flexible flat cable 23 and extends backward inside the casing 21. Then, the guide belt 26 is curved and folded back inside the casing 21 and extends forward to be fixed to the front end 21h of the casing 21.

As shown in FIG. 6A, the guide belt 26 is a long belt-shaped guide member extending substantially in the front to rear direction. The guide belt 26 is made of, for example, a metal material such as stainless steel or resin material. The guide belt 26 is disposed inside the casing 21 so that the thickness direction of the guide belt 26 coincides with the right to left direction of the casing 21, the width direction coincides with the up to down direction of the casing 21, and the longitudinal direction coincides with the front to rear direction of the casing 21.

As shown in FIG. 7, the guide belt 26 is formed in a cross-sectional shape of a circular arc that is convex toward the flexible flat cable 23. The guide belt 26 is disposed so that a convex surface 26A faces the flexible flat cable 23.

The guide belt 26 includes a moving end 26a which is attached to the sliding portion 22 together with the tip portion 23a of the flexible flat cable 23, a fixed end 26b which is fixed to the casing 21 together with the base end 23b, and a curved portion 26c which is provided between the moving end 26a and the fixed end 26b in a curved state. The curved portion 26c is a part of the belt intermediate portion between the moving end 26a and the fixed end 26b of the guide belt 26, and is a portion that is curved into a substantially U-shape in top view as the sliding portion 22 moves.

The moving end 26a is attached to the sliding portion 22, and moves in the front to rear direction together with the tip portion 23a of the flexible flat cable 23 in accordance with the forward and backward movement of the sliding portion 22.

The fixed end 26b is attached to the front end 21h of the casing 21 and is fixed to the casing 21 together with the base end 23b of the flexible flat cable 23. The curved portion 26c is provided to be curved along the flexible flat cable 23 and guides the flexible flat cable 23.

The holding member 27 is a member that holds the guide belt 26 in order to suppress rattling of the guide belt 26 in the up to down direction and is made of resin or the like. The holding member 27 is provided between the fixed end 26b and the curved portion 26c of the guide belt 26, and includes a base portion 28 which is disposed on the right side of the guide belt 26 and a locking portion 29 which is provided in the base portion 28 and locks the guide belt 26.

As shown in FIG. 6A, when the sliding portion 22 is located at a forward position, the holding member 27 is located in the vicinity of the curved portion 26c. As shown in FIG. 6B, when the sliding portion 22 moves backward to an intermediate position, the holding member 27 is located at a position between the fixed end 26b and the curved portion 26c. As shown in FIG. 6C, when the sliding portion 22 further moves backward to a backward position, the holding member 27 is located at a position between the fixed end 26b and the curved portion 26c separated from the curved portion 26c.

In this way, the guide belt 26 is held by the locking portion 29 of the holding member 27 between the fixed end 26b and the curved portion 26c. Accordingly, regardless of the position of the curved portion 26c in the front to rear direction, the downward bending moment applied to the curved portion 26c is reduced, and deformation of the guide belt 26 due to gravity or the like is suppressed. Thus, the lower edge of the guide belt 26 is less likely to come into contact with the casing bottom wall 21a of the casing 21, so that the generation of abnormal noise can be suppressed.

As shown in FIG. 7, the holding member 27 is provided in the casing 21 to face a concave surface 26B of the guide belt 26. That is, the base portion 28 is provided at a position facing the concave surface 26B on the opposite side to the convex surface 26A near the flexible flat cable 23 in the guide belt 26.

Furthermore, the holding member 27 may be provided in the casing 21 to face the convex surface 26A of the guide belt 26. That is, the base portion 28 may be provided at a position facing the convex surface 26A near the flexible flat cable 23 in the guide belt 26 (between the guide belt 26 and the flexible flat cable 23).

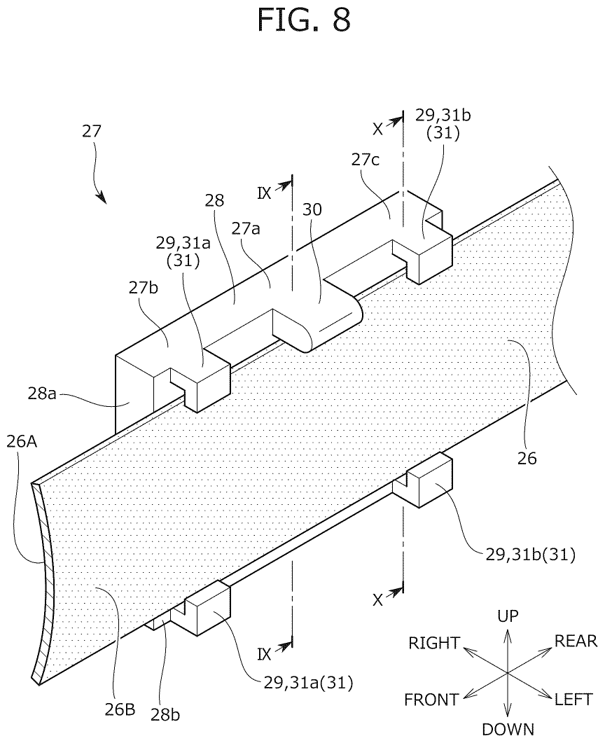

The base portion 28 is, for example, a long plate-shaped member that extends in the front to rear direction along the guide belt 26. As shown in FIG. 8, the base portion 28 is disposed at a position overlapping the guide belt 26 in the right to left direction which is the thickness direction of the guide belt 26.

The locking portion 29 is a portion that locks the end (upper or lower end) of the guide belt 26 in the width direction. The locking portion 29 is provided to protrude from the base portion 28 toward the guide belt 26 at a central part 27a, a front part 27b, and a rear part 27c of the holding member 27. The locking portion 29 extends from the end of the base portion 28 in the up to down direction to the left and overlaps the guide belt 26 in the up to down direction.

Furthermore, in this embodiment, the locking portion 29 is provided at three positions of the central part 27a, the front part 27b, and the rear part 27c of the holding member 27. However, the present invention is not limited thereto, and the locking portion 29 may be provided in any one part of the central part 27a, the front part 27b, and the rear part 27c.

As shown in FIG. 8, the locking portion 29 includes a bulging portion 30 which locks the upper end of the guide belt 26 and a claw portion 31 which locks the upper and lower ends of the guide belt 26. That is, the guide belt 26 is accommodated in a space surrounded by the base portion 28 and the bulging portion 30 and the claw portion 31 of the locking portion 29.

Furthermore, in the locking portion 29, the bulging portion 30 is provided in the central part 27a, the front locking piece 31a is provided in the front part 27b, and the rear locking piece 31b is provided in the rear part 27c. However, the present invention is not limited thereto, the bulging portion 30 may be provided in the front part 27b and the rear part 27c, and the claw portion 31 may be provided in the central part 27a. Further, each of the central part 27a, the front part 27b, and the rear part 27c may be provided with the bulging portion 30, and each of the central part 27a, the front part 27b, and the rear part 27c may be provided with the claw portion 31.

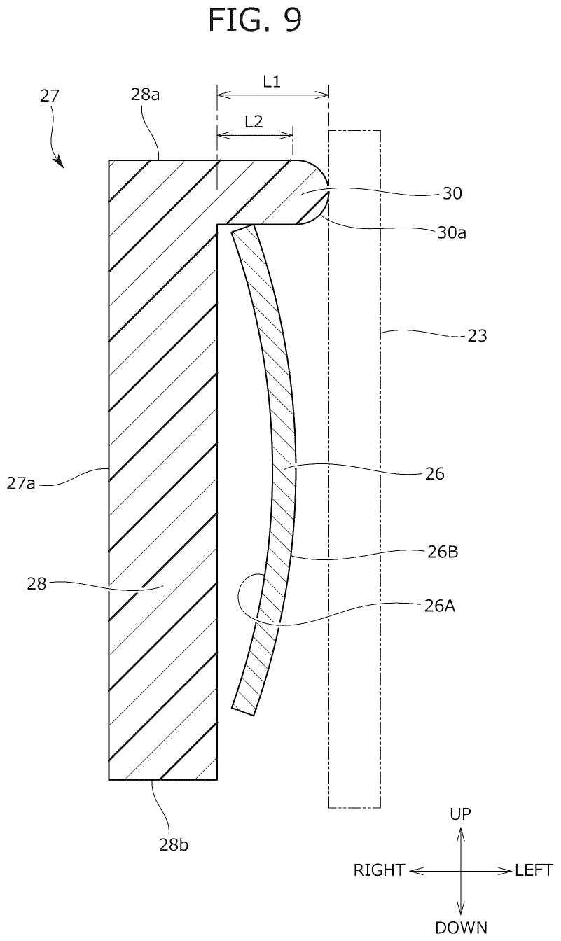

As shown in FIGS. 8 and 9, the bulging portion 30 extends from an upper end 28a of the base portion 28 to the left at a central position (central part 27a) in the front to rear direction as the extension direction of the base portion 28 and overlaps the guide belt 26 in the up to down direction. That is, the bulging portion 30 locks the upper end of the guide belt 26.

The lower surface of the bulging portion 30 comes into contact with the upper end of the guide belt 26, and a tip surface 30a of the bulging portion 30 comes into contact with the flexible flat cable 23. The tip surface 30a of the bulging portion 30 has a rounded shape.

Furthermore, in this embodiment, the bulging portion 30 is provided at the upper end 28a, but may be provided at the lower end 28b. Further, the bulging portion 30 may be provided at both the upper end 28a and the lower end 28b.

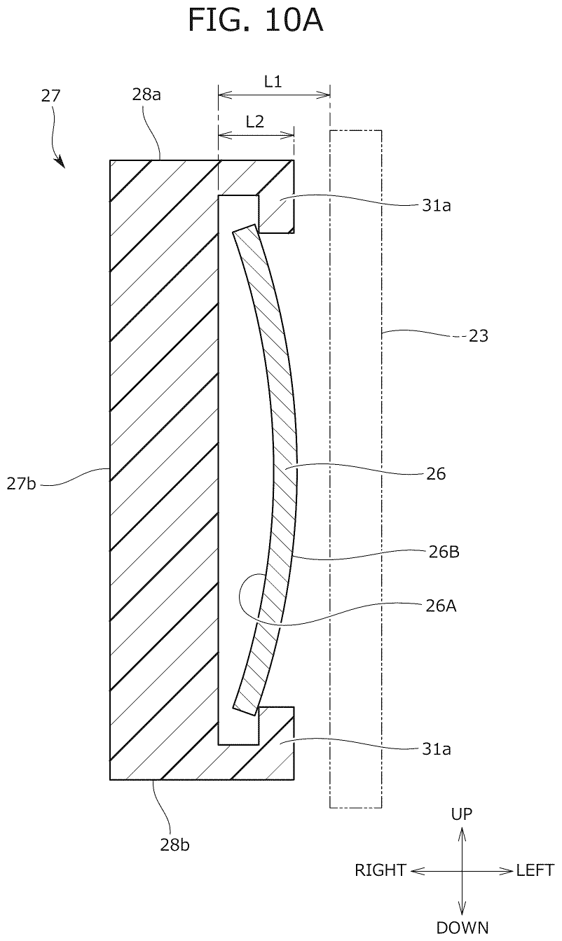

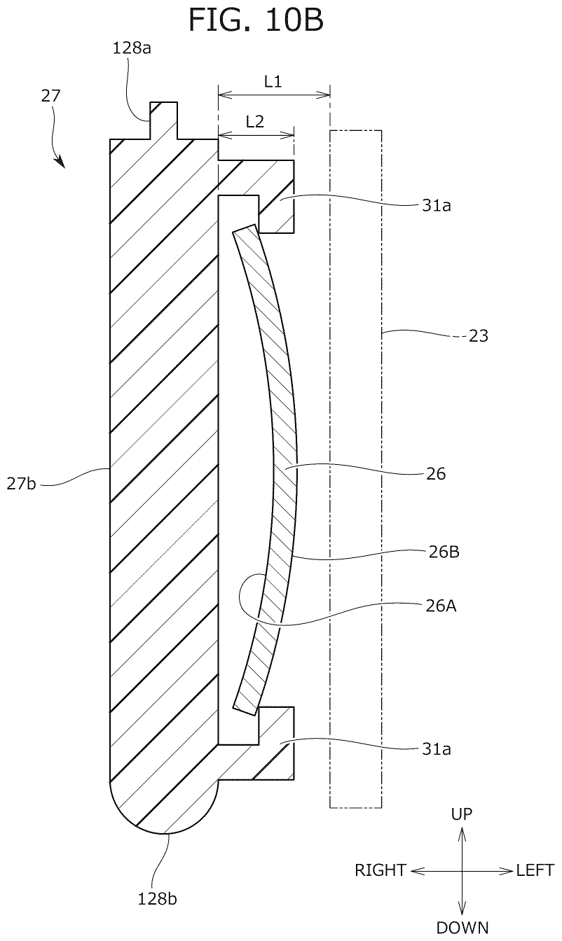

As shown in FIGS. 8 and 10A, the claw portion 31 extends from the upper end 28a and the lower end 28b of the base portion 28 to the left at both end parts (the front part 27b and the rear part 27c) in the front to rear direction of the base portion 28 and overlaps in the up to down direction. That is, the claw portion 31 locks the upper and lower ends of the guide belt 26.

Furthermore, in this embodiment, the claw portion 31 is provided at the upper end 28a and the lower end 28b, but may be provided at any one of the upper end 28a and the lower end 28b.

As shown in FIGS. 9 and 10, the length L1 of the bulging portion 30 is longer than the length L2 of the claw portion 31 in the right to left direction. Therefore, since the bulging portion 30 which is longer than the claw portion 31 comes into contact with the flexible flat cable 23, the guide belt 26 is held at a position separated from the flexible flat cable 23. Further, even when the tip surface 30a of the bulging portion 30 comes into contact with the flexible flat cable 23, it is possible to suppress the flexible flat cable 23 from being worn down by the holding member 27 since the tip surface 30a has a rounded shape.

In this way, the holding member 27 can stably hold the guide belt 26 by holding the end of the guide belt 26 in the up to down direction by the locking portion 29. Then, since the guide belt 26 is stably held by the holding member 27, the lower edge of the guide belt 26 is less likely to collide with the casing bottom wall 21a of the casing 21 at the curved portion 26c. In this way, the generation of abnormal noise can be suppressed.

Furthermore, in order to suppress rattling of the holding member 27 in the up to down direction, the holding member 27 may be attached to be in contact with the casing 21. For example, when an elastic member that biases the holding member 27 in the up to down direction is provided, the holding member 27 may be held to the casing 21 by the biasing force of the elastic member.

Further, the locking portion 29 shown in FIG. 10A extends from the upper and lower end surfaces of the base portion 28 in the thickness direction of the base portion 28, overlaps the guide belt 26 in the up to down direction, and holds the end of the guide belt 26 in the up to down direction. However, the present invention is not limited thereto, and as shown in FIG. 10B, the locking portion 29 may be provided at a position closer to the center than the upper and lower end surfaces at the upper and lower ends of the base portion 28. Furthermore, the upper and lower ends of the base portion 28 refer to the areas other than the central portion in the up to down direction.

As shown in FIG. 10B, the base portion 28 of the holding member 27 according to a modified example includes a step upper end 128a which has a step on the upper end surface and a curved surface lower end 128b which has a curved surface on the lower end surface. Since the step upper end 128a and the curved surface lower end 128b are provided, the thickness of the base portion 28 at the upper and lower ends is thinner than the thickness of the central portion.

### Manufacturing Method

A method of manufacturing the vehicle seat S will be described.

First, a worker prepares a seat body including the seat cushion 1 and the seat back 2. Then, the worker attaches the seat body to the slide rail 10 extending in the front to rear direction as a predetermined direction to be movable in the front to rear direction. Specifically, the worker fixes the seat support member 3 of the seat body above the upper rail 12 of the slide rail 10.

Then, the worker disposes the power supply rail 20 on the side of the slide rail 10 along a direction in which the slide rail 10 extends. Specifically, the worker disposes the casing 21 of the power supply rail 20 to be adjacent to the slide rail 10 in the rail groove formed in the floor F. Further, the worker electrically connects the movable terminal portion 24 of the power supply rail 20 to the slide rail 10. Specifically, the worker connects the movable terminal portion 24 connected to the tip portion 23a of the flexible flat cable 23 to the connector (not shown) provided in the upper rail 12 of the slide rail 10. Further, the worker electrically connects the fixed terminal portion 25 of the power supply rail 20 to the power source P provided in the vehicle body.

In this way, power from the power source P is supplied to the upper rail 12 of the slide rail 10 through the power supply rail 20.

Furthermore, the power supply rail 20 includes the casing 21 which extends in the front to rear direction and has a cylindrical shape, the sliding portion 22 which is attached to the casing 21 to be movable along the front to e is rear direction, the flexible flat cable 23 which accommodated in the casing 21 and extends in the front to rear direction, the movable terminal portion 24 which is provided at the tip portion 23a of the flexible flat cable 23 and is attached to the sliding portion 22, the fixed terminal portion 25 which is provided at the base end 23b of the flexible flat cable 23 and is attached to the casing 21, the guide belt 26 which is accommodated in the casing 21, extends in the front to rear direction along the flexible flat cable 23, and guides the flexible flat cable 23, and the holding member 27 that holds the guide belt 26.

The flexible flat cable 23 includes the tip portion 23a which is connected to the movable terminal portion 24 and the base end 23b which is connected to the fixed terminal portion. The guide belt 26 includes the moving end 26a which is attached to the sliding portion 22 together with the tip portion 23a, the fixed end 26b which is fixed to the casing 21 together with the base end 23b, and the curved portion 26c which is provided between the moving end 26a and the fixed end 26b in a curved state.

The holding member 27 is provided between the fixed end 26b and the curved portion 26c, and includes the base portion 28 which is provided at a position overlapping the guide belt 26 in the right to left direction and the locking portion 29 which extends from the upper end or the lower end of the base portion 28 in the right to left direction and overlaps the guide belt 26 in the up to down direction. Then, the holding member 27 holds the guide belt 26 by the locking portion 29.

Furthermore, the base portion 28 may extend in the front to rear direction along the guide belt 26, and the bulging portion 30 of the locking portion 29 may extend from the upper end in the right to left direction at the central part of the base portion 28 in the extension direction and overlap the guide belt 26 in the up to down direction.

Further, the base portion 28 may extend in the front to rear direction along the guide belt 26, and the claw portion 31 of the locking portion 29 may extend from the upper end or the lower end in the right to left direction at the side end part of the base portion 28 in the extension direction and overlap the guide belt 26 in the up to down direction.

Further, the base portion 28 may extend in the front to rear direction along the guide belt 26 and be provided at a position facing the concave surface 26B on the opposite side to the convex surface 26A near the flexible flat cable 23 in the guide belt 26.

Further, the length of the bulging portion 30 may be longer than the length of the claw portion 31 in the right to left direction.

The method of manufacturing the vehicle seat S is as follows.

A method of manufacturing a vehicle seat, including:
preparing a seat body including a seat cushion and a seat back;
attaching the seat body to a slide rail, extending in a predetermined direction, to be movable in the predetermined direction; and
disposing a power supply rail on the side of the slide rail along a direction in which the slide rail extends,
wherein the power supply rail includes: a casing which extends in the predetermined direction and has a cylindrical shape; a sliding portion which is attached to the casing to be movable along the predetermined direction; a flexible flat cable which is accommodated in the casing and extends along the predetermined direction; a movable terminal portion which is provided at one end of the flexible flat cable and is attached to the sliding portion; a fixed terminal portion which is provided at the other end of the flexible flat cable and is attached to the casing; a guide belt which is accommodated in the casing, extends in the predetermined direction along the flexible flat cable, and guides the flexible flat cable; and a holding member that holds the guide belt, wherein the flexible flat cable includes a tip portion which is connected to the movable terminal portion and a base end which is connected to the fixed terminal portion, wherein the guide belt includes a moving end which is attached to the sliding portion together with the tip portion, a fixed end which is fixed to the casing together with the base end, and a curved portion which is provided between the moving end and the fixed end in a curved state, wherein the holding member is provided between the fixed end and the curved portion, includes a locking portion which locks at least one end of the guide belt in a width direction, and holds the guide belt by the locking portion, and wherein the method further includes: electrically connecting the movable terminal portion of the power supply rail to the slide rail.

In the method of manufacturing the vehicle seat, the holding member includes a base portion which is disposed at a position overlapping the guide belt in a thickness direction of the guide belt and the locking portion, and the locking portion extends in the thickness direction from at least one end of the base portion in the width direction of the guide belt and overlaps the guide belt in the width direction.

In the method of manufacturing the vehicle seat, the base portion extends in the predetermined direction along the guide belt, and the locking portion extends in the thickness direction from at least one end of the base portion in the width direction at a central part of the base portion in an extension direction and overlaps the guide belt in the width direction.

In the method of manufacturing the vehicle seat, the base portion extends in the predetermined direction along the guide belt, and the locking portion extends in the thickness direction from at least one end of the base portion in the width direction in at least one side end part of the base portion in an extension direction and overlaps the guide belt in the width direction.

In the method of manufacturing the vehicle seat, the base portion extends in the predetermined direction along the guide belt, and the locking portion extends in the thickness direction from at least one end of the base portion in the width direction at both end parts of the base portion in an extension direction and overlaps the guide belt in the width direction.

In the method of manufacturing the vehicle seat, the base portion extends in the predetermined direction along the guide belt and is provided at a position facing a surface opposite to a surface near the flexible flat cable in the guide belt, and the locking portion extends in the thickness direction from both ends of the base portion in the width direction and overlaps the guide belt in the width direction.

In the method of manufacturing the vehicle seat, the base portion extends in the predetermined direction along the guide belt and is provided at a position facing a surface opposite to a surface near the flexible flat cable in the guide belt, the locking portion includes a bulging portion which extends in the thickness direction from at least one end of the base portion in the width direction at a central part of the base portion in an extension direction and overlaps the guide belt in the width direction and a claw portion which extends in the thickness direction from at least one end of the base portion in the width direction at both end parts of the base portion in an extension direction and overlaps the guide belt in the width direction, and the length of the bulging portion is longer than the length of the claw portion in the thickness direction.

### First Modified Example

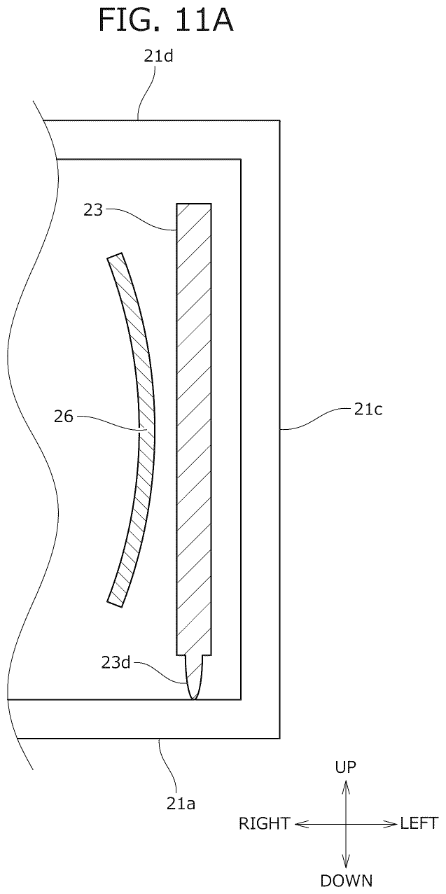

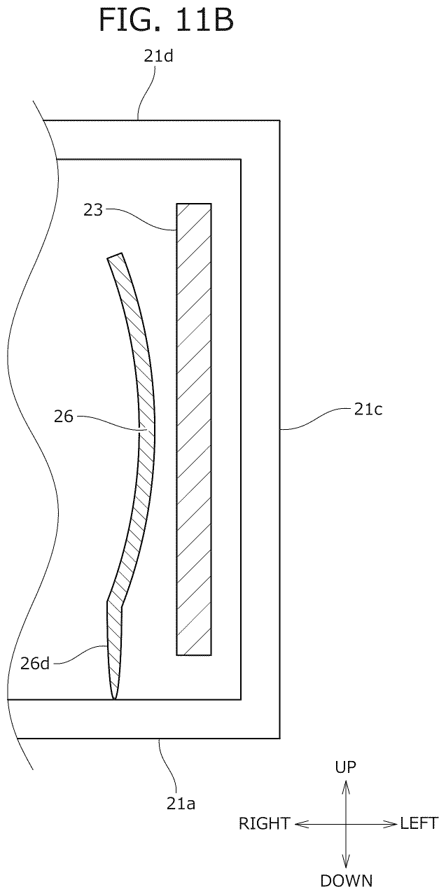

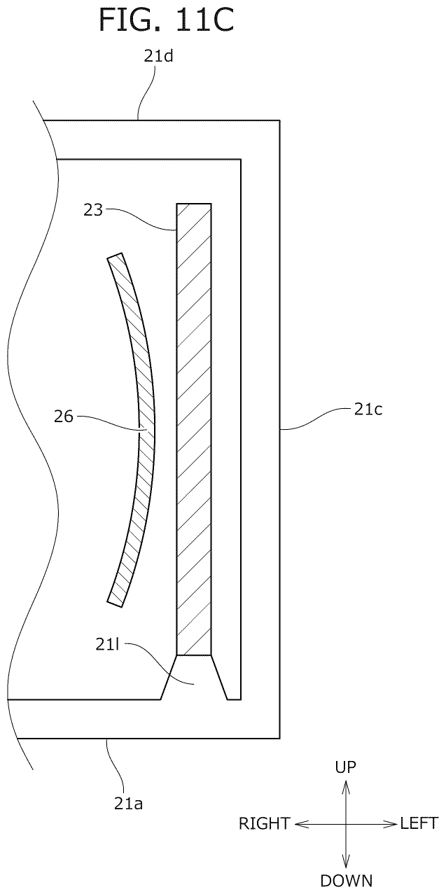

Next, a first modified example of the power supply rail 20 will be described with reference to FIG. 11A. Furthermore, the description of the overlapping content of the power supply rail 20 described above is omitted.

In the power supply rail 20 of the first modified example, as shown in FIG. 11A, a protrusion 23d is formed in the flexible flat cable 23.

Specifically, the protrusion 23d is formed at the lower end of the flexible flat cable 23. The protrusion 23d has a substantially inverted triangular shape when viewed from the right to left direction, and a plurality of (for example, three) protrusions are arranged in the front to rear direction. The formation position of the protrusion 23d is, for example, between the base end 23b and the intermediate portion 23c of the flexible flat cable 23 and is in front of the holding member 27.

In this way, since the protrusion 23d is formed in the flexible flat cable 23, deformation of the flexible flat cable 23 due to gravity or the like is less likely to occur in the intermediate portion 23c. Thus, since the excessive contact between the flexible flat cable 23 and the casing bottom wall 21a of the casing 21 can be suppressed, the generation of abnormal noise can be suppressed.

### Second Modified Example

Next, a second modified example of the power supply rail 20 will be described with reference to FIG. 11B.

In the power supply rail 20 of the second modified example, as shown in FIG. 11B, a protrusion piece 26d is formed in the guide belt 26.

Specifically, the protrusion piece 26d is formed at the lower end of the guide belt 26. The protrusion piece 26d has a substantially inverted triangular shape when viewed from the right to left direction, and a plurality of (for example, three) protrusion pieces are arranged in the front to rear direction. The formation position of the protrusion piece 26d is, for example, between the fixed end 26b and the curved portion 26c of the guide belt 26 and is in front of the holding member 27.

In this way, since the protrusion piece 26d is formed in the guide belt 26, deformation of the guide belt 26 due to gravity or the like is less likely to occur in the curved portion 26c. Thus, since the excessive contact between the guide belt 26 and the casing bottom wall 21a of the casing 21 can be suppressed, the generation of abnormal noise can be suppressed.

### Third Modified Example

Next, a third modified example of the power supply rail 20 will be described with reference to FIG. 11C.

In the power supply rail 20 of the third modified example, as shown in FIG. 11C, a raised portion 211 is formed in the casing bottom wall 21a of the casing 21.

Specifically, the raised portion 211 that is raised upward from the casing bottom wall 21a is formed at a position corresponding to the flexible flat cable 23 of the casing bottom wall 21a (in the vicinity of the left wall portion 21c). The raised portion 211 has a substantially trapezoidal cross-sectional shape when viewed from the front to rear direction and is formed to extend in the front to rear direction. The formation position of the raised portion 211 is, for example, between the base end 23b and the intermediate portion 23c of the flexible flat cable 23 in the casing bottom wall 21a and is in front of the holding member 27.

In this way, since the raised portion 211 is formed in the casing bottom wall 21a, deformation of the flexible flat cable 23 due to gravity or the like is less likely to occur in the intermediate portion 23c. Thus, since the excessive contact between the flexible flat cable 23 and the casing bottom wall 21a of the casing 21 can be suppressed, the generation of abnormal noise can be suppressed.

### Fourth Modified Example

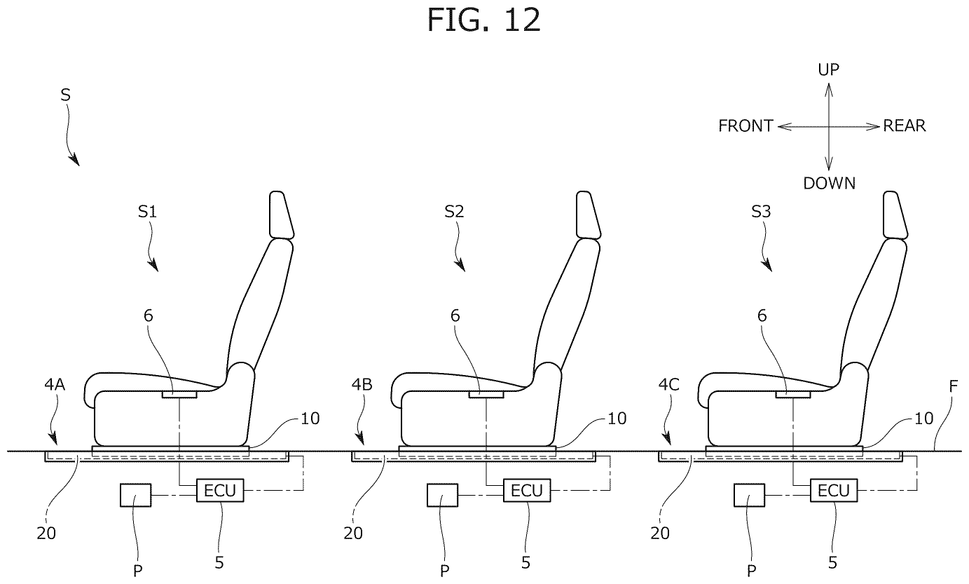

Next, a fourth modified example of the vehicle seat S will be described with reference to FIG. 12.

As shown in FIG. 12, the vehicle seat S of the fourth modified example includes a front seat S1 corresponding to the front seat of the vehicle, a middle seat S2 in the second row, and a rear seat S3 in the third row in the vehicle having three rows of seats in the front to rear direction. As shown in FIG. 12, the vehicle seat S includes the plurality of rail devices 4 which support each seat body to be movable forward and backward. Specifically, the vehicle seat S includes a front rail device 4A which supports the seat body of the front seat S1 to be movable forward and backward, a middle rail device 4B which supports the seat body of the middle seat S2 to be movable forward and backward, and a rear rail device 4C which supports the seat body of the rear seat S3 to be movable forward and backward.

In this way, even when the plurality of vehicle seats S are provided, power can be supplied from the power source P to each slide rail 10 of the vehicle seat S through each power supply rail 20.

Furthermore, in this embodiment, the plurality of the control devices 5 and the power sources P are provided and are connected to each rail device 4, but the present invention is not limited thereto. For example, each of the control device 5 and the power source P may be commonly provided in each rail device 4.

### Fifth Modified Example

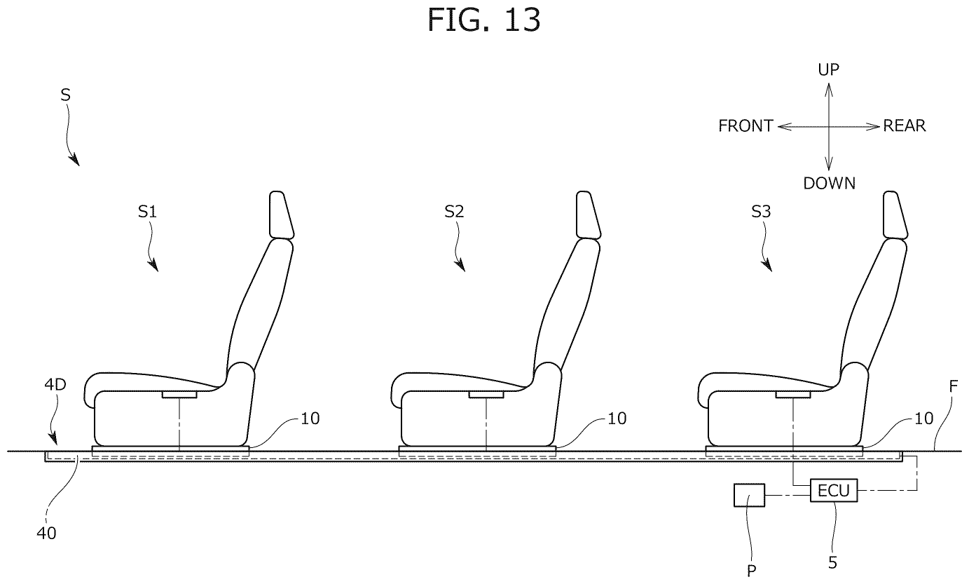

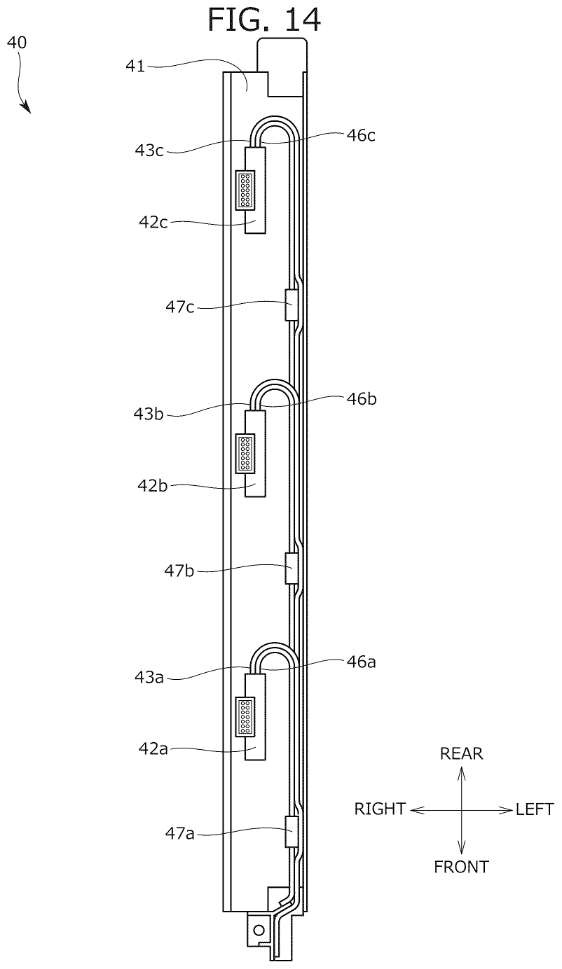

Next, a fifth modified example of the vehicle seat S will be described with reference to FIGS. 13 and 14.

As shown in FIG. 13, the vehicle seat S of the fifth modified example includes a front seat S1 corresponding to the front seat of the vehicle, a middle seat S2 in the second row, and a rear seat S3 in the third row in the vehicle having three rows of seats in the front to rear direction.

As shown in FIG. 13, the vehicle seat S includes a long rail device 4D which is long and supports each seat body to be movable forward and backward. The long rail device 4D includes a long power supply rail 40 which supplies power to the slide rail 10 of the front seat S1, the slide rail 10 of the middle seat S2, and the slide rail 10 of the rear seat S3.

As shown in FIG. 14, the long power supply rail 40 includes a long casing 41 that extends long in the front to rear direction and accommodates a power supply mechanism for each vehicle seat S. Specifically, the long power supply rail 40 includes a first sliding portion 42a for the front seat S1, a second sliding portion 42b for the middle seat S2, and a third sliding portion 42c for the rear seat S3.

Further, the long power supply rail 40 includes a first flexible flat cable 43a for the front seat S1, a second flexible flat cable 43b for the middle seat S2, and a third flexible flat cable 43c for the rear seat S3.

Then, the long power supply rail 40 includes a first guide belt 46a for the front seat S1, a second guide belt 46b for the middle seat S2, and a third guide belt 46c for the rear seat S3.

Further, the long power supply rail 40 includes the first holding member 47a for the front seat S1, the second holding member 47b for the middle seat S2, and the third holding member 47c for the rear seat S3.

In this way, even when the plurality of vehicle seats S are provided, power can be supplied from the power source P to each slide rail 10 of the vehicle seat S through the long power supply rail 40. Then, since the first holding member 47a, the second holding member 47b, and the third holding member 47c are provided in the long casing 41, deformation of the first guide belt 46a, the second guide belt 46b, and the third guide belt 46c is less likely to occur.

In the above-described embodiment, a configuration in which an extension direction (a predetermined direction) of the slide rail 10 and the power supply rail 20 is the front to rear direction has been described as an example, but the present invention is not limited thereto. The slide rail 10 and the power supply rail 20 may be provided to extend in the right to left direction as a predetermined direction or may extend in a direction other than the front to rear direction and the right to left direction.

Further, in the above-described embodiment, the power supply rail and the vehicle seat used in an automobile are described as specific examples, but the present invention is not limited to such applications and can be used for various seats such as two-wheeler seats, vehicle seats for trains and buses, seats for vehicles such as airplanes and ships, as well as office chairs for work, wheelchairs, and child seats in shopping carts.

In this embodiment, the power supply rail and the vehicle seat according to the present invention have been mainly described.

However, the above-described embodiment is merely an example for facilitating understanding of the present invention, and does not limit the present invention. The present invention can be modified and improved without departing from the spirit of the present invention, and the present invention naturally includes equivalents thereof.

### REFERENCE SIGNS LIST

S: vehicle seat
   S1: front seat
   S2: middle seat
   S3: rear seat
F: floor
P: power source
1: seat cushion
   1a: pad material
   1b: skin material
2: seat back
   2a: pad material
   2b: skin material
3: seat support member
4: rail device
   4A: front rail device
   4B: middle rail device
   4C: rear rail device
5: control device
6: operation switch
10: slide rail
11: lower rail
   11a: rail inner wall
12: upper rail
   12a: upper surface
13: electric motor
   13a: motor bracket
14: drive shaft
15: gear casing
   15a: gear bracket
   15b: casing opening
16: screw member
   16a: first bearing portion
   16b: second bearing portion
   16c: third bearing portion
17: first screw member
18: second screw member
19: screw engagement portion
   19a: first engagement portion
   19b: second engagement portion
20: power supply rail
21: casing
   21a: casing bottom wall
   21b: right wall portion
   21c: left wall portion
   21d: upper wall portion
   21e: intermediate wall portion
   21f: slit
   21g: canopy portion
   21h: casing of front end
   21i: casing of rear end
   21j: cover
   21k: opening
   21l: raised portion
22: sliding portion
   22a: main body portion
   22b: protrusion portion
   22c: connector attachment portion
   22d: connection portion
   22e: flat cable attachment portion
23: flexible flat cable
   23a: tip portion
   23b: base end
   23c: intermediate portion
   23d: protrusion
24: movable terminal portion
   24a: movable cable
   24b: movable connector
25: fixed terminal portion
   25a: fixed cable
   25b: fixed connector
26: guide belt
   26A: concave surface
   26B: convex surface
   26a: moving end
   26b: fixed end
   26c: curved portion
   26d: protrusion piece
27: holding member
   27a: central part
   27b: front part (side end part, both end parts)
   27c: rear part (side end part, both end parts)
28: base portion
   28a: upper end
   28b: lower end
   128a: step upper end
   128b: curved surface lower end
29: locking portion
30: bulging portion
31: claw portion
   31a: front locking piece
   31b: rear locking piece
4D: long rail device
40: long power supply rail
41: long casing
42a: first sliding portion
42b: second sliding portion
42c: third sliding portion
43a: first flexible flat cable
43b: second flexible flat cable
43c: third flexible flat cable
46a: first guide belt
46b: second guide belt
46c: third guide belt
47a: first holding member
47b: second holding member
47c: third holding member

1. A power supply rail, comprising:
a casing which extends in a predetermined direction and has a cylindrical shape;
a sliding portion which is attached to the casing to be movable along the predetermined direction;
a flexible flat cable which is accommodated in the casing and extends along the predetermined direction;
a movable terminal portion which is provided at one end of the flexible flat cable and is attached to the sliding portion;
a fixed terminal portion which is provided at the other end of the flexible flat cable and is attached to the casing;
a guide belt which is accommodated in the casing, extends in the predetermined direction along the flexible flat cable, and guides the flexible flat cable; and
a holding member that holds the guide belt,
wherein the flexible flat cable includes a tip portion which is connected to the movable terminal portion and a base end which is connected to the fixed terminal portion,
wherein the guide belt includes a moving end which is attached to the sliding portion together with the tip portion, a fixed end which is fixed to the casing together with the base end, and a curved portion which is provided between the moving end and the fixed end in a curved state, and
wherein the holding member is provided between the fixed end and the curved portion, includes a locking portion which locks at least one end of the guide belt in a width direction, and holds the guide belt by the locking portion.

2. The power supply rail according to claim 1,
wherein the holding member includes a base portion which is disposed at a position overlapping the guide belt in a thickness direction of the guide belt and the locking portion, and
wherein the locking portion extends in the thickness direction from at least one end of the base portion in the width direction of the guide belt and overlaps the guide belt in the width direction.

3. The power supply rail according to claim 2,
wherein the base portion extends in the predetermined direction along the guide belt, and
wherein the locking portion extends in the thickness direction from at least one end of the base portion in the width direction at a central part of the base portion in an extension direction and overlaps the guide belt in the width direction.

4. The power supply rail according to claim 2,
wherein the base portion extends in the predetermined direction along the guide belt, and
wherein the locking portion extends in the thickness direction from at least one end of the base portion in the width direction in at least one side end part of the base portion in an extension direction and overlaps the guide belt in the width direction.

5. The power supply rail according to claim 2,
wherein the base portion extends in the predetermined direction along the guide belt, and
wherein the locking portion extends in the thickness direction from at least one end of the base portion in the width direction at both end parts of the base portion in an extension direction and overlaps the guide belt in the width direction.

6. The power supply rail according to claim 2,
wherein the base portion extends in the predetermined direction along the guide belt and is provided at a position facing a surface opposite to a surface near the flexible flat cable in the guide belt, and
wherein the locking portion extends in the thickness direction from both ends of the base portion in the width direction and overlaps the guide belt in the width direction.

7. The power supply rail according to claim 2,
wherein the base portion extends in the predetermined direction along the guide belt and is provided at a position facing a surface opposite to a surface near the flexible flat cable in the guide belt,
wherein the locking portion includes a bulging portion which extends in the thickness direction from at least one end of the base portion in the width direction at a central part of the base portion in an extension direction and overlaps the guide belt in the width direction and a claw portion which extends in the thickness direction from at least one end of the base portion in the width direction at both end parts of the base portion in an extension direction and overlaps the guide belt in the width direction, and
wherein the length of the bulging portion is longer than the length of the claw portion in the thickness direction.

8. A vehicle seat, comprising:
a seat body which includes a seat cushion and a seat back;
a slide rail which extends in the predetermined direction and supports the seat body to be movable in the predetermined direction; and
the power supply rail according to claim 1,
wherein the power supply rail is disposed on the side of the slide rail along a direction in which the slide rail extends.

9. A method of manufacturing a vehicle seat, comprising:
preparing a seat body which includes a seat cushion and a seat back;
attaching the seat body to a slide rail which extends in a predetermined direction so that the seat body is movable in the predetermined direction; and
disposing a power supply rail on the side of the slide rail along a direction in which the slide rail extends,
wherein the power supply rail includes a casing which extends in the predetermined direction and has a cylindrical shape, a sliding portion which is attached to the casing to be movable along the predetermined direction, a flexible flat cable which is accommodated in the casing and extends along the predetermined direction, a movable terminal portion which is provided at one end of the flexible flat cable and is attached to the sliding portion, a fixed terminal portion which is provided at the other end of the flexible flat cable and is attached to the casing, a guide belt which is accommodated in the casing, extends in the predetermined direction along the flexible flat cable and guides the flexible flat cable, and a holding member that holds the guide belt,
wherein the flexible flat cable includes a tip portion which is connected to the movable terminal portion and a base end which is connected to the fixed terminal portion,
wherein the guide belt includes a moving end which is attached to the sliding portion together with the tip portion, a fixed end which is fixed to the casing together with the base end, and a curved portion which is provided between the moving end and the fixed end in a curved state,
wherein the holding member is provided between the fixed end and the curved portion, includes a locking portion which locks at least one end of the guide belt in a width direction, and holds the guide belt by the locking portion, and
wherein the method further comprises electrically connecting the movable terminal portion of the power supply rail to the slide rail.

10. The method according to claim 9,
wherein the holding member includes a base portion which is disposed at a position overlapping the guide belt in a thickness direction of the guide belt and the locking portion, and
wherein the locking portion extends in the thickness direction from at least one end of the base portion in the width direction of the guide belt and overlaps the guide belt in the width direction.

11. The method according to claim 10,
wherein the base portion extends in the predetermined direction along the guide belt, and
wherein the locking portion extends in the thickness direction from at least one end of the base portion in the width direction at a central part of the base portion in an extension direction and overlaps the guide belt in the width direction.

12. The method according to claim 10,
wherein the base portion extends in the predetermined direction along the guide belt, and
wherein the locking portion extends in the thickness direction from at least one end of the base portion in the width direction in at least one side end part of the base portion in an extension direction and overlaps the guide belt in the width direction.

13. The method according to claim 10,
wherein the base portion extends in the predetermined direction along the guide belt, and
wherein the locking portion extends in the thickness direction from at least one end of the base portion in the width direction at both end parts of the base portion in an extension direction and overlaps the guide belt in the width direction.

14. The method according to claim 10,
wherein the base portion extends in the predetermined direction along the guide belt and is provided at a position facing a surface opposite to a surface near the flexible flat cable in the guide belt, and
wherein the locking portion extends in the thickness direction from both ends of the base portion in the width direction and overlaps the guide belt in the width direction.

15. The method according to claim 10,
wherein the base portion extends in the predetermined direction along the guide belt and is provided at a position facing a surface opposite to a surface near the flexible flat cable in the guide belt,
wherein the locking portion includes a bulging portion which extends in the thickness direction from at least one end of the base portion in the width direction at a central part of the base portion in an extension direction and overlaps the guide belt in the width direction and a claw portion which extends in the thickness direction from at least one end of the base portion in the width direction at both end parts of the base portion in an extension direction and overlaps the guide belt in the width direction, and
wherein the length of the bulging portion is longer than the length of the claw portion in the thickness direction.
